(19) United States
(12) Patent Application Publication
(10) Pub. No.: US 2009/0160870 A1
(43) Pub. Date: Jun. 25, 2009

(54) RUN-TIME RECONFIGURABLE FABRIC FOR 3D TEXTURE FILTERING SYSTEM

(76) Inventors: Wei-Ting WANG, Taichung City (TW); Hui-Chin YANG, Hsinchu City (TW); R-Ming HSU, Jhudong Township (TW); Chung-Ping CHUNG, Hsinchu City (TW)

Correspondence Address: SINORICA, LLC, 2275 Research Blvd., Suite 500, ROCKVILLE, MD, 20850, US

(21) Appl. No.: 12/333,376

(22) Filed: Dec. 12, 2008

(30) Foreign Application Priority Data
Dec. 24, 2007 (TW) 096149798

(51) Int. Cl. G09G 5/00

(52) U.S. Cl. 345/582

(57) ABSTRACT

The present invention discloses a texture filtering system, comprising a sequence generator, a retrieve unit and a dispatch unit. The sequence generator generates an execution sequence in each duty cycle. The execution sequence is the priority of respectively retrieving multiple pixels from multiple queues. The retrieve unit outputs multiple Boolean signals based on the limitation of the total number of all-purpose texture filters and the above priority in a duty cycle for determining from which queues the pixels are retrieved to perform a texture filtering process, and the dispatch unit assigns the multiple texture filter formats of the pixels to be processed and the anisotropic ratios thereof to multiple address generators. Besides, the present invention utilizes Brute force method to enable multiple bilinear texture filters to satisfy the various texture filter formats of a pixel, thereby markedly reducing the space occupied by the texture filter in a 3D graphic processing unit, provided that the specifications of the address generators and texture cache memory are unchanged.

### BACKGROUND OF THE INVENTION

(a) Field of the Invention

The present invention relates to a hardware architecture for the 3D graphic processing unit, and more particularly, to a hardware architecture of a texture unit of texture filtering system.

(b) Description of the Prior Art

At the present day, the main function of high level display cards is provided for playing 3D games. The 3D gaming is subject to the field of run-time rendering, while ultra-high resolution and accuracy like those in industrial design or in motion pictures are not required. Instead, what is concerned is fast and smooth rendering of frames. It is necessary to create at least 30 frames in one second such that the players will not feel lagging of the frames. Therefore, many opportunistic technologies are applied in 3D graphic processing units (GPU) for entertainment purposes. Basically, the process of creating 3D graphics can be divided into three steps of “framework building up”, “texture mapping” and “screen outputting”, which are respectively described as below:

Currently, the object shape of the 3D image is formed based on triangles or polygons. All the objects in a game are stacked by a plurality of triangles, and each triangle is composed of three vertexes. This is why the objects in earlier 3D games are so angulate. In other words, it requires a large number of triangles or polygons to form an arc-like object. If a display card is not powerful enough to process a great deal of triangles or polygons, only a small amount of triangles or polygons can be used to form the object shapes, and consequently results in angulate objects.

After the framework of an object has been built up with triangles, the object has an outer border frame. To make if more recognizable, a skin is required for the framework, i.e. the texture, which is a monotonic picture composed of pixels. Followed by texture mapping, the original objects will become various emulated objects. Finally, these 3D objects are projected onto a 2D screen to generate the 3D graphics.

Among the above procedures, a texture unit serves to download the textures required by the game from memory to a computing center, and also provides the function of texture filtering. The reason for texture filtering is that objects are located far or near in a 3D world from the user's viewpoint, and the farther object merely needs smaller textures. The texture filtering is used to downsize a big picture to a smaller picture which is then attached to the farther object. The number of texture units would affect the texture mapping speed and the game image quality so that the more is better. However, the current trend of 3D computation is towards great shuddering on a single texture so that texture units dominate the image quality after filtering.

Referring to FIG. 1 for a schematic view which shows a structure of a 3D graphic processing unit in prior art. The graphic processing unit 10 comprises multiple mechanisms 11 for pixel processing before texture mapping, multiple queues 12 for storing the pixels to undergo a texture filtering process, multiple texture units 13 and multiple mechanisms 17 for pixel processing after texture mapping. Each texture unit 13 comprises three parts: an address generator 14, a cache memory 15 and a texture filter 16. Many conventional designs of texture unit with small chip area emphasize in decrease of areas of the address generator 14 and the cache memory 15. However, the texture filter 16 also has high computational demands and is a member, which occupies the chip area to a relatively great extent. Therefore, if the chip area occupied by the texture filter 16 can be reduced without impairing the execution performance of the texture filter 16, it will be able to efficiently reduce the chip area occupied by the entire texture unit 13 in the graphic processing unit 10.

Please referring to FIG. 2, the texture filter formats required for each pixel in texture mapping may be different, and the common texture filter formats are nearest neighbor interpolation, bilinear interpolation, tri-linear interpolation, anisotropic interpolation and the like. Therefore, as illustrated in FIG. 2, the current texture filter 16 usually comprises a bilinear texture filter 161, a tri-linear texture filter 162 and an anisotropic texture filter 163 for dedicating to various texture filtering. However, these specialized texture filters are not in use all the time, it causes the lowering the overall service efficiency of the texture filter 16 and insidiously increasing the redundant space occupied by the texture filter 16 in the texture unit 13.

Alternatively, U.S. Pat. No. 6,778,188 B2 discloses a programmable filter comprising two linear filters as basic elements applicable for texture filtering and image processing. Wherein the application of texture filtering supports bilinear algorithm and tri-linear algorithm, and the application of image processing supports convolution algorithm and bicubic algorithm. However, other filters such as the anisotropic texture filter are not considered.

In view of the problems and insufficiencies of the prior art, the inventors propose a run-time reconfigurable fabric for a texture filtering system based on their research and development for many years and plenty of practical experience in order to improve the above drawbacks.

### SUMMARY OF THE INVENTION

In view of the above-mentioned problems, an object of the present invention is to provide a run-time reconfigurable fabric for a texture filtering system in order to reduce the space occupied by the texture filter in a 3D graphic processing unit.

According to the object of the present invention, an all-purpose texture filtering system is provided. The texture filtering system comprises a plurality of bilinear texture filters and a filter logic unit which are used to replace tri-linear texture filters and anisotropic texture filters. The multiple bilinear texture filters are combined to form a plurality of tri-linear texture filters and anisotropic texture filters by the filter logic unit with a Brute force method, in order to satisfy the various texture filter formats required by pixels. Accordingly, the all-purpose texture filter of the present invention can improve the overall service efficiency of the texture filter, thereby reducing the space occupied by the texture unit in a 3D graphic processing unit.

According to the object of the present invention, a texture filtering system is further provided. The texture filtering system comprises a sequence generator, a retrieve unit and a dispatch unit. The sequence generator is for generating the priority of respectively retrieving multiple pixels from multiple queues in each duty cycle. The retrieve unit outputs a plurality of Boolean signals based on the limitation of the total number of all-purpose texture filters and said priority in a duty cycle, for determining from which queues the pixels are retrieved to perform a texture filtering process. Finally, the dispatch unit assigns the multiple texture filter formats of the pixels to be processed and the anisotropic ratios of such pixels to multiple address generators based on the Boolean signals. As a result, the texture filtering system of the present invention employs the sequence generator, the retrieve unit and the dispatch unit to improve the service efficiency of the all-purpose texture filter so as to compensate for the time delay caused by the all-purpose texture filter.

As mentioned above, the run-time reconfigurable fabric for a texture filtering system according to the present invention can enable multiple bilinear texture filters to substitute for various texture filter formats, provided that the specifications of the address generators and texture cache memory are unchanged. Accordingly, the space occupied by the texture filter in a 3D graphic processing unit can be efficiently reduced.

The technical features and effects of the present invention may be better understood and appreciated through the preferred embodiment of the present invention described in more detail below.

### BRIEF DESCRIPTION OF THE DRAWINGS

The run-time reconfigurable fabric for a texture filtering system according to the preferred embodiment of the present invention is described with reference to the related drawings. For the convenience of understanding, the same reference numerals as in the following embodiment designate the same elements.

FIG. 1 is a schematic view showing a structure of a graphic processing unit in prior art;

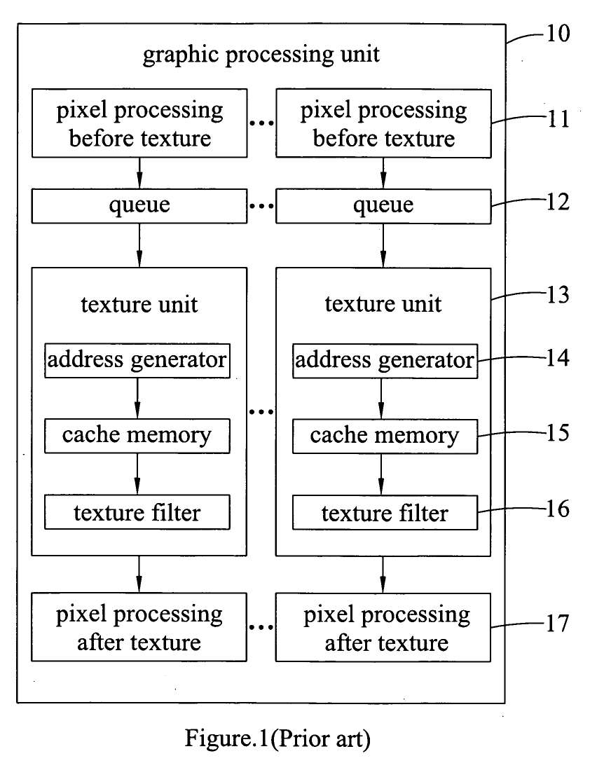

FIG. 2 is a schematic view showing a structure of a texture filter in prior art;

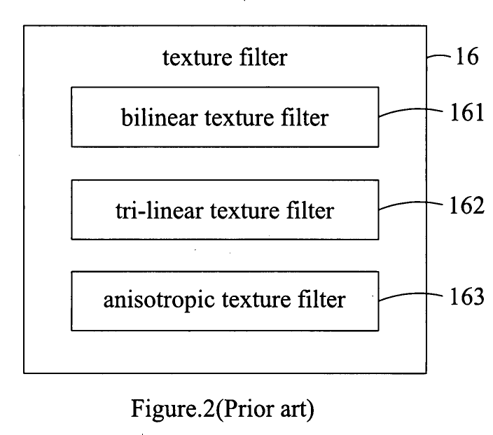

FIG. 3 is a circuit structure diagram showing the bilinear texture filters according to the present invention in substitution for a tri-linear texture filter;

FIG. 4 is a circuit structure diagram showing the bilinear texture filters according to the present invention in substitution for an anisotropic texture filter;

FIG. 5 is a schematic view showing a structure of an all-purpose texture filter according to the present invention;

FIG. 6 is a circuit structure diagram of an all-purpose texture filter according to an embodiment of the present invention;

FIG. 7 is a schematic view showing another structure of an all-purpose texture filter according to the present invention;

FIG. 8 is a circuit structure diagram of an all-purpose texture filter according to another embodiment of the present invention;

FIG. 9 is a schematic view showing a structure of a graphic processing unit according to the present invention;

FIG. 10 is a circuit structure diagram of a graphic processing unit according to an embodiment of the present invention;

FIG. 11 is a circuit structure diagram of the sequence generator according to an embodiment of the present invention; and

FIG. 12 is a circuit structure diagram of the dispatch unit according to an embodiment of the present invention.

### DETAILED DESCRIPTION OF THE PREFERRED EMBODIMENTS

In order to improve the overall service efficiency of the texture filter, that is, not limited to the necessity of processing the pixels which require bilinear texture processing with bilinear texture filters, processing the pixels which require tri-linear texture processing with tri-linear texture filters, and processing the pixels which require anisotropic texture processing with anisotropic texture filters, the present invention discloses an all-purpose texture filter, whose rationale is as follows.

The present invention utilizes a number of bilinear texture filters and an extra logic unit to substitute for tri-linear texture filters and anisotropic texture filters. In other words, the present invention can use a number of bilinear texture filters and an extra logic unit to construct an all-purpose texture filter. The bilinear texture filtering equation is represented by the following:

$${Bi}_{( x , y )} = {\sum }_{i = 0}^{3} ( {T}_{i} \times {W}_{i} ) \qquad ( 1 )$$

wherein Bi represents the bilinear texture filtering, Tᵢ represents the texture and Wᵢ represents the weighting coefficient of the texture. The tri-linear texture filtering equation is represented by the following:

$${Tri}_{( x , y )} = {\sum }_{l = 0}^{1} ( {Bi}_{( x , y ) l} \times {W}_{i} ) \qquad ( 2 )$$

wherein Tri represents the tri-linear texture filtering. And the anisotropic texture filtering equation is represented by the following:

$$n : 1 {\_Ani}_{( x , y )} = {\sum }_{i = 0}^{n - 1} ( {Tri}_{i} \times {W}_{a} ) . \qquad ( 3 )$$

Therefore, the Brute force method can be used to separate the tri-linear texture filter equation into two bilinear texture filter equations according to the present invention, that is,

$$\begin{matrix}{Tri}_{( TF )} = {Bi}_{( TF ) 1} \times {Li}_{( WG ) 1} + {Bi}_{( TF ) 0} \times {Li}_{( WG ) 0} \\ = {Bi}_{( TF ) 1} + ( {Bi}_{( TF ) 0} - {Bi}_{( TF ) 1} ) \times LF .\end{matrix} \qquad ( 4 )$$

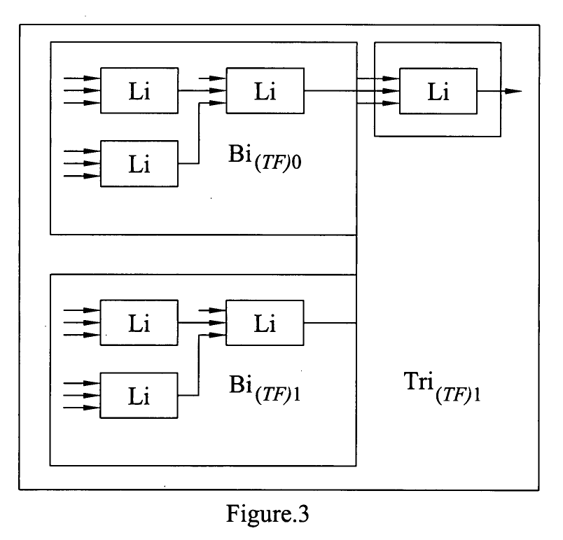

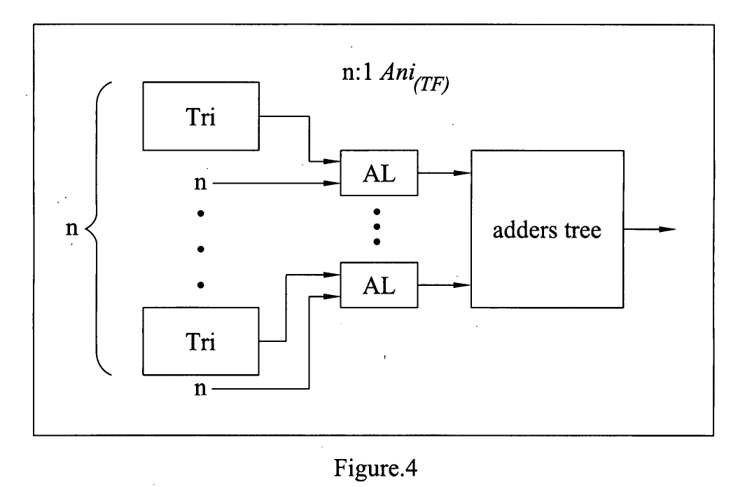

However, such separation only ensures that the input throughput of the tri-linear texture filter can be covered in two bilinear texture filters. In actual calculation, the work, which a tri-linear texture filter can complete in a duty cycle, still needs to be multiplexed by two bilinear texture filters in a first duty cycle, and then integrated by using a bilinear texture filter in a second duty cycle. FIG. 3 illustrates a circuit structure diagram showing the bilinear texture filters according to the present invention in substitution for a tri-linear texture filter. From the drawing, we can observe that the two bilinear texture filters Bi can cover the input throughput of a tri-linear texture filter Tri through a multiplexed signal TF. The circuit in the drawing utilizes two logical configurations of the multiplexed signal TF, i.e. TF0 and TF1, to achieve the purpose of multiplexing, and the bilinear texture filter Bi illustrated in the drawing is actually comprised of three linear texture filters Li. It should be noted that in reality, 7 linear texture filters Li are required to construct the tri-linear texture filter Tri so that in the actual operation, the two bilinear texture filters Bi can cover the input throughput of a tri-linear texture filter Tri in the first duty cycle, but it is still necessary to provide the seventh linear texture filter Li in the second duty cycle. In like manner, referring to FIG. 4 for a circuit structure diagram showing the bilinear texture filters according to the present invention in substitution for an anisotropic texture filter, we can observe that an n:1 anisotropic texture filter Ani can be resolved into n tri-linear texture filters Tri to cover its input throughput via a number of anisotropic logics AL, and then integrated by an adders tree during floating point operations.

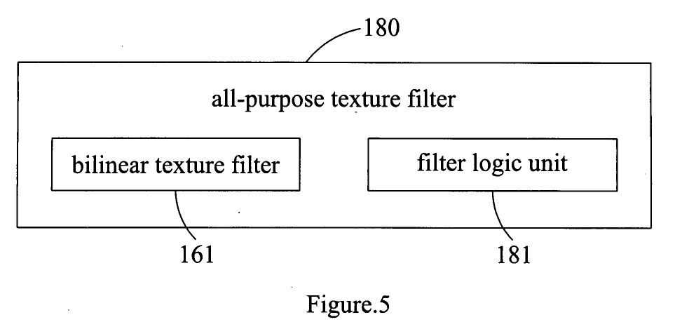

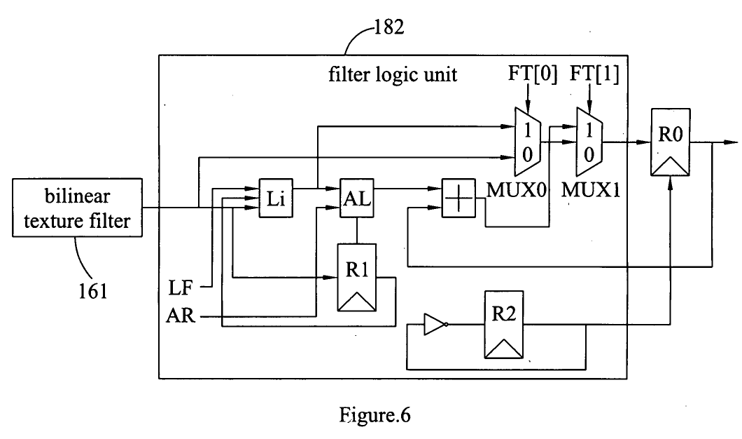

Therefore, first of all, the present invention provides an all-purpose texture filter based on the above principle. Referring to FIG. 5 for a schematic view showing a structure of an all-purpose texture filter according to the present invention, the all-purpose texture filter 180 according to the present invention comprises a bilinear texture filter 161 and a filter logic unit 181. Next, referring to FIG. 6 for a circuit structure diagram of an all-purpose texture filter according to an embodiment of the present invention, a filter logic unit 182 is electrically connected to the bilinear texture filter 161 and receives the anisotropic ratios AR of the pixels to be processed and a combined parameter LF. The combined parameter LF is derived from the above-mentioned equation (4), which is generated by adjusting the weighting coefficients when combining two bilinear texture processors. To achieve the purpose of the substitution of tri-linear texture processors with bilinear texture processors in two duty cycles, the filter logic unit 182 includes an extra linear texture filter Li. To achieve the substitution of n:1 anisotropic texture processors with tri-linear texture processors in 2n duty cycles, the filter logic unit 182 includes an extra 16-bit counter R1 to store the results outputted from the tri-linear texture processors. In addition, the filter logic unit 182 also includes an extra anisotropic logic AL for segmenting the results outputted from each of the tri-linear texture processors, and an adder (+) for adding all the results outputted from the tri-linear texture processors. The filter logic unit 182 uses two bits to represent texture filter format FT for various texture filter formats, for example, FT(00) represents the bilinear texture processor, and FT(01) represents the tri-linear texture processor, and FT(10) represents the anisotropic texture processor. A multiplexer MUX0 is employed to distinguish whether the texture filter format is a bilinear texture format or not, and a multiplexer MUX1 is employed to distinguish whether the texture filter format is a tri-linear texture format or not. Finally, a 1-bit counter R2 is used for calculating whether the duty cycle is an even or odd cycle. The 16-bit counter R0 illustrated in FIG. 6, is excluded from the filter logic unit 182 because the counter R0 is a necessary counter while a texture unit is used for the output of a pipeline.

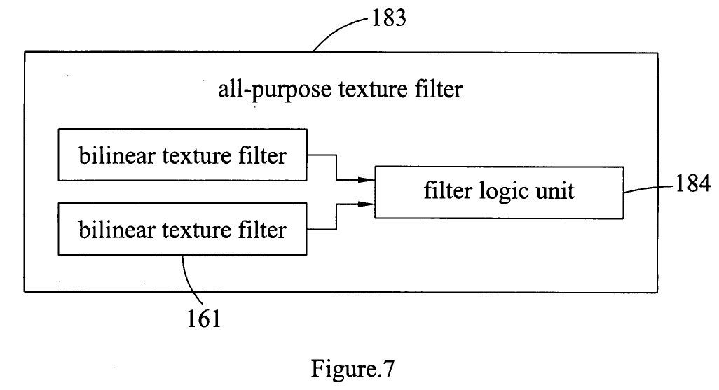

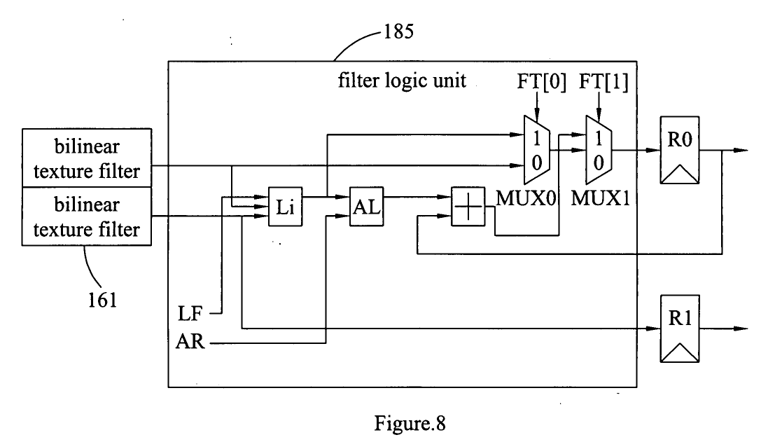

Referring to FIG. 7 for a schematic view showing another structure of an all-purpose texture filter according to the present invention, the all-purpose texture filter 183 comprises two bilinear texture filters 161 and a filter logic unit 184. Accordingly, the all-purpose texture filter 183 can substitute for the tri-linear texture filter. Next, referring to FIG. 8 for a circuit structure diagram of an all-purpose texture filter according to another embodiment of the present invention, the function of each member of a filter logic unit 185 is the same as that of each member of the filter logic unit 183 as illustrated in FIG. 6 and not further described in detail here. When the texture filter format of a pixel is the bilinear texture filter format, the pixel can be selectively inputted to either of the two bilinear texture filters 161, and be outputted from either of the 16-bit counter R1 or R0. When the texture filter format of a pixel is the tri-linear texture filter format, the pixel can be inputted to the two bilinear texture filters 161 to meet the input throughput required by tri-linear texture filtering, and pass through the linear texture filter Li, and then be outputted from the 16-bit counter R0. When the texture filter format of a pixel is an anisotropic texture filter format, the pixel can be inputted into the two bilinear texture filters 161, and passes through the linear texture filter Li, the anisotropic logic AL and the adder (+), and then be outputted from the 16-bit counter R0 in each duty cycle.

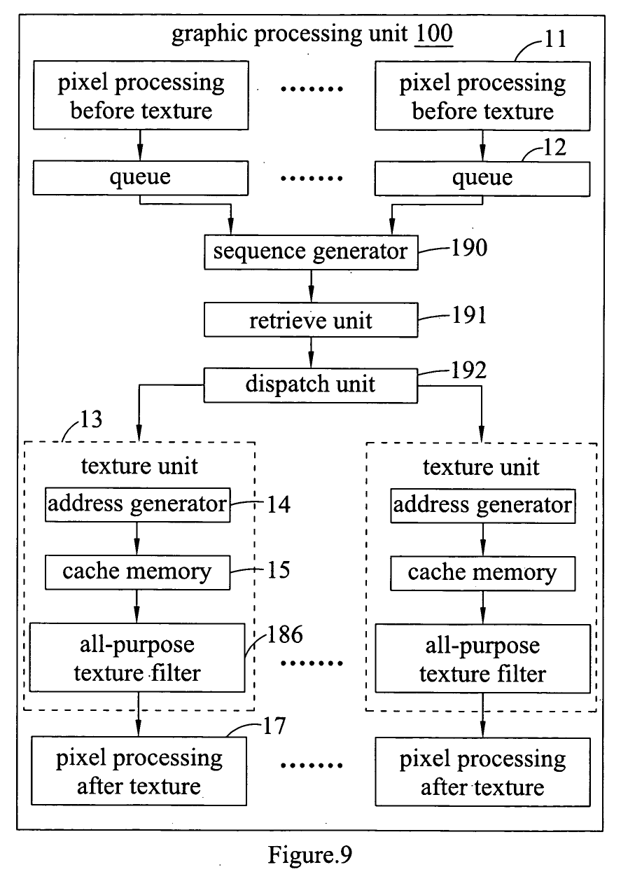

Therefore, as illustrated in FIGS. 6 and 8, the all-purpose texture filter 183 can substitute for a tri-linear texture filter, and can further substitute for an anisotropic texture filter, whereupon the all-purpose texture filter can significantly improve the overall service efficiency of the texture filter. In other words, the all-purpose texture filter of the present invention can complete the work, which was done by conventional texture filter components, by using fewer texture filter components, thereby reducing the chip area occupied by the texture filter in a graphic processing unit. However, even though an all-purpose texture filter can be formed by a bilinear texture filter and a filter logic unit, when the number of the texture units in a texture filtering system increases, each all-purpose texture filter still requires a filter logic unit. Therefore, the present invention further provides a run-time reconfigurable fabric for a texture filtering system to enable multiple texture units to share the filter logic unit of multiple all-purpose texture filters. Referring to FIG. 9 for a schematic view showing a structure of a graphic processing unit according to the present invention, first, the conventional texture filter 16 is substituted with an all-purpose texture filter 186, and then a pixel passes through a sequence generator 190, a retrieve unit 191 and a dispatch unit 192 in order before being inputted to an address generator 14, thereby the pixels can be uniformly distributed among a number of texture units 13 in order to the utilization rate of the texture filter.

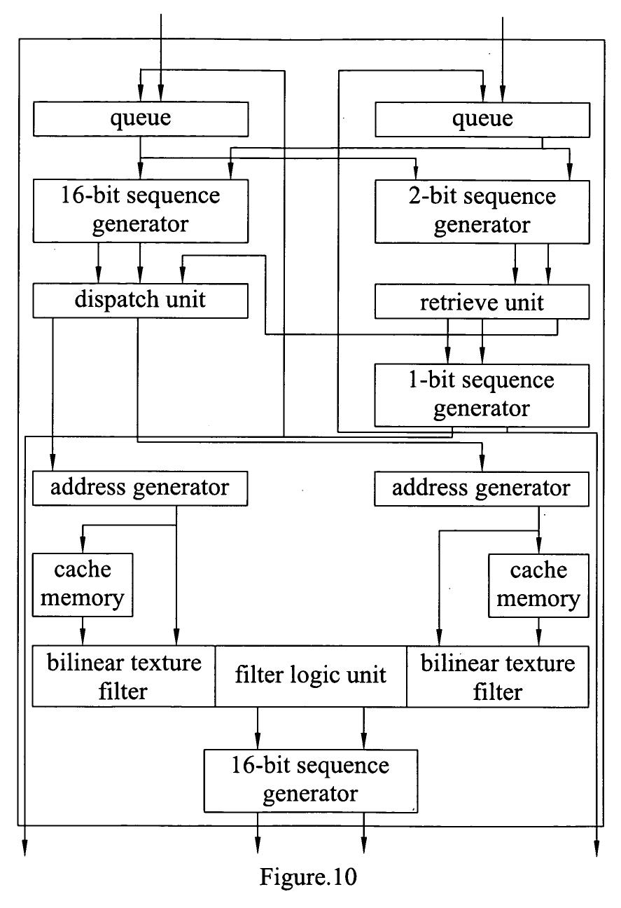

Next, referring to FIG. 10 for a circuit structure diagram of a graphic processing unit according to an embodiment of the present invention, two pixels are inputted into a 2-bit sequence generator from two queues, and the 2-bit sequence generator generates an execution sequence for determining the priority of processing the two pixels. The retrieve unit outputs two Boolean signals to the dispatch unit based on the limitation of the total number of the input throughputs of an all-purpose texture filter, which comprises two bilinear texture filters and a filter logic unit, and the above priority in a duty cycle. The 16-bit sequence generator retrieves the texture filter formats and anisotropic ratios of two pixels from two queues, and inputs them into the dispatch unit in sequence. Finally, the dispatch unit assigns the texture filter formats and the anisotropic ratios of the two pixels to two address generators in accordance with the Boolean signals. Two pixels to be processed are inputted to the all-purpose texture filter through the address generators and cache memories for texture filtering, and the all-purpose texture filter comprises two bilinear texture filters and a filter logic unit, and then two pixels are outputted from the 16-bit sequence generator. Accordingly, the all-purpose texture filter can reduce the chip area, which is occupied by the texture unit in a graphic processing unit. The resource dispatch in an all-purpose texture filter is compensated by improving the service efficiency of the all-purpose texture filter by using a sequence generator, a retrieve unit and a dispatch unit.

The sequence generator generates the priority of respectively retrieving pixels from multiple queues in each duty cycle. The retrieve unit outputs multiple Boolean signals based on the limitation of the total number of sharable all-purpose texture filters and the above priority in a duty cycle for determining from which queues the pixels are retrieved to perform a texture filtering process, and the dispatch unit assigns the multiple texture filter formats of the pixels to be processed and the anisotropic ratios thereof to multiple address generators.

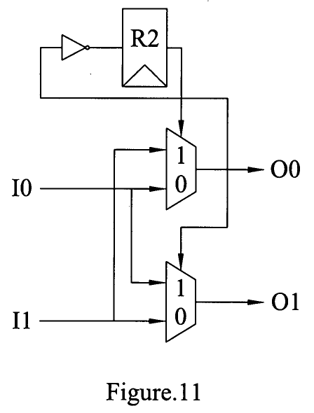

Next, referring to FIG. 11 for a circuit structure diagram of the sequence generator 190 according to an embodiment of the present invention, the illustrated sequence generator comprises two multiplexers (MUX) and a counter R2, and functions to multiplex the data simultaneously inputted by two input ends 10 and 11 for generating an output sequence, and then the data is outputted from output ends O0 and O1 in sequence. Therefore, the n n-t0-1 multiplexers can in turn output n simultaneously inputted signals in terms of the clock of the counter to generate an execution sequence. Due to the simple structure of multiplexers, the sequence generator 190 of this embodiment would not occupy much of the configuration space of the graphic processing unit 100.

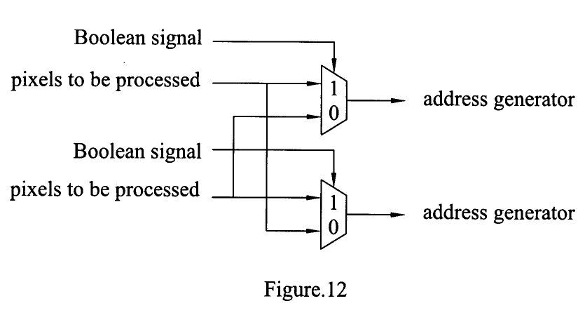

Next, referring to FIG. 12 for a circuit structure diagram of the dispatch unit 192 according to an embodiment of the present invention, the dispatch unit comprises two multiplexers (MUX). The dispatch unit is capable of accommodating two pixels to be processed and determining to which address generators these two pixels to be processed should be outputted based on Boolean signals. On the analogy of this, one dispatch unit 192 which can accommodate n pixels needs n n-to-I multiplexers (MUX) to respectively output the data to n address generators based on the Boolean signal of each pixel. Due to the simple structure of multiplexers, the dispatch unit 192 of this embodiment would also not occupy much of the configuration space of the graphic processing unit 100.

The above-described embodiment is only illustrative, but not limitative. Various equivalent modifications or changes to the present invention can be made to the elements of the present invention without departing from the spirit and scope of this invention. Accordingly, all such equivalent modifications and changes shall fall within the scope of the appended claims.

What is claimed is:

1. A texture filtering system comprising:
a sequence generator for generating an execution sequence in each duty cycle;
a retrieve unit for outputting a plurality of Boolean signals based on a total number of a plurality of texture filters and a execution sequence in a duty cycle, for determining the priority of retrieving a plurality of pixels from a plurality of queues; and
a dispatch unit for assigning a plurality of texture filter formats and a plurality of anisotropic ratios of the plurality of pixels to a plurality of address generators according to the plurality of Boolean signals.

2. The texture filtering system of claim 1, wherein each of the plurality of texture filters comprises a plurality of bilinear texture filters and a filter logic unit.

3. The texture filtering system of claim 2, wherein each of the plurality of texture filters is capable of performing a bilinear texture filtering process.

4. The texture filtering system of claim 2, wherein the plurality of bilinear texture filters are formed into a plurality of tri-linear texture filters by the filter logic unit with the Brute force method.

5. The texture filtering system of claim 4, wherein each of the plurality of texture filters is capable of performing a tri-linear texture filtering process.

6. The texture filtering system of claim 2, wherein the plurality of bilinear texture filters are formed into a plurality of anisotropic texture filters by the filter logic unit with the Brute force method.

7. The texture filtering system of claim 6, wherein each of the plurality of texture filters is capable of performing an anisotropic texture filtering process.
